(19) United States
(12) Patent Application Publication
(10) Pub. No.: US 2008/0016228 A1
(43) Pub. Date: Jan. 17, 2008

(54) METHOD AND APPARATUS FOR PREVENTING DATA LEAKAGE IN PORTABLE TERMINAL

(75) Inventor: Hak-Bong CHO, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/778,328

(22) Filed: Jul. 16, 2007

(30) Foreign Application Priority Data
Jul. 14, 2006 (KR) 2006-0066288

(51) Int. Cl. G06F 15/16

(52) U.S. Cl. 709/228; 709/227

(57) ABSTRACT

Provided are a method of preventing data leakage from a portable terminal and an apparatus employing the method. The method includes checking whether computer identification (ID) data from a computer is received when the portable terminal is connected to the computer using a media transfer protocol (MTP). A computer authentication using the computer ID data is performed when the computer ID data is received.

### PRIORITY

This application claims priority under 35 U.S.C. § 119 to an application filed in the Korean Intellectual Property Office on Jul. 14, 2006 and assigned Serial No. 2006-66288, the contents of which are incorporated herein by reference.

### BACKGROUND OF THE INVENTION

1. Field of the Invention

The present invention relates generally to an apparatus and method for preventing leakage of data in a portable terminal, and more particularly, to an apparatus and method for preventing leakage of recorded data from the memory of a portable terminal by performing an authenticating process of a computer using a media transfer protocol used by the portable terminal when the computer is connected to the portable terminal.

2. Description of the Related Art

A Media Transfer Protocol (MTP) is a progression from the Picture Transfer Protocol (PTP) designed to transfer image data of photos taken in digital cameras to computers so that moving image files can also be transferred.

Currently, users are able to use a Microsoft Windows search function to transfer media files saved in an internal or external memory of a portable terminal supporting MTP to a computer.

FIG. 1 shows the process of connecting an MTP between a portable terminal and a computer, according to the prior art.

Referring to FIG. 1, first, when a computer 102 and a portable terminal 100 supporting the MTP are connected in step 110 using the MTP, the computer 102 sends a request for data to the portable terminal 100 in step 112, and the portable terminal 100 receives the request for data and sends data on its capability to the computer 102 in step 114. This data includes data on the memory (in terms of internal and external memory) and characteristics of the portable terminal. Here, the memory data includes memory type, total memory size, remaining memory capacity, description data, serial numbers, etc., and the characteristic data of the portable terminal includes operation codes, lists of supported functions, manufacturer, model name, version data, etc.

Then, the computer 102 requests a list of media files stored in the memory of the portable terminal 100 in step 116, and the portable terminal 100 transfers the handles of the stored media files to the computer 102 in step 118. Next, the computer 102 requests metadata of the media files from the portable terminal 100 in step 120, and the portable terminal 100 transfers the requested metadata of the media files to the computer 102 in step 122. The portable terminal 100 and the computer 102 then respectively transfer and receive the media files in step 124.

As described above, the MTP supporting the portable terminal and the computer according to the prior art transfer and receive media files without an authentication process. Thus, in the event that the portable terminal or an external memory device of the portable terminal is lost or stolen, the data stored in the memory can easily be leaked, stolen or misappropriated without authorization.

### SUMMARY OF THE INVENTION

An aspect of the present invention is to substantially solve at least the above problems and/or disadvantages and to provide at least the advantages below. Accordingly, an aspect of the present invention is to provide an apparatus and method for preventing data leakage from a memory of a portable terminal.

Another aspect of the present invention is to provide an apparatus and method for preventing data leakage from a memory of a portable terminal by performing an authentication process during an MTP connection of the portable terminal to a computer.

According to a first aspect of the present invention, there is provided a method of preventing data leakage from a portable terminal, including checking whether computer identification (ID) data from a computer is received when the portable terminal is connected to the computer using a Media Transfer Protocol (MTP); and performing a computer authentication using the computer ID data, when the computer ID data is received.

According to a second aspect of the present invention, there is provided a method of operating a computer to prevent data leakage from a portable terminal, including transferring computer ID data to the portable terminal when the computer is connected to the portable terminal using MTP; and requesting content data stored in the portable terminal when a signal signaling a successful authentication is received from the portable terminal.

According to a third aspect of the present invention, there is provided an apparatus for preventing data leakage from a portable terminal, including a checking unit for determining whether a computer authentication is successful using ID data of a computer and a user PIN (Personal Identification Number), when the portable terminal is connected to the computer using an MTP; and a controller for maintaining or canceling the connection between the portable terminal and the computer according to whether the computer authentication is successful.

### BRIEF DESCRIPTION OF THE DRAWINGS

The above and other objects, features and advantages of the present invention will become more apparent from the following detailed description when taken in conjunction with the accompanying drawings in which:

FIG. 1 shows a process of connecting an MTP between a portable terminal and a computer, according to the prior art;

FIG. 2 shows a process of connecting an MTP between a portable terminal and a computer according to the present invention;

FIG. 3 is a block diagram showing the components of a portable terminal according to the present invention;

FIGS. 4A and 4B are flowcharts showing MTP connecting processes for preventing leaking of data from a portable terminal according to the present invention; and

FIG. 5 is a flowchart showing a process of connecting a computer to a portable terminal according to the present invention.

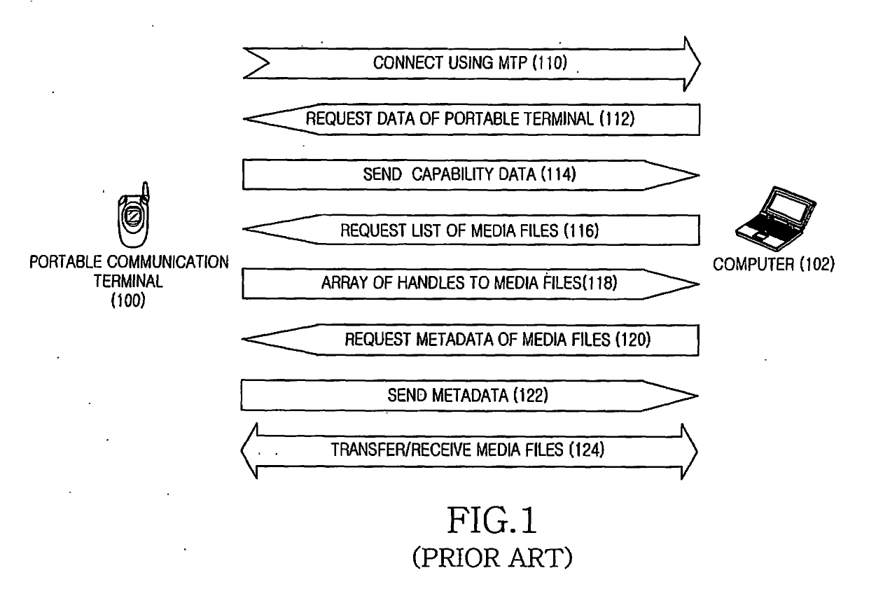

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Below, by performing an authentication process during an MTP connection between a portable terminal and a computer, the present invention provides a method and apparatus for preventing data leaks from the memory of the portable terminal. The portable terminal described below encompasses all types of portable terminals that support MTP.

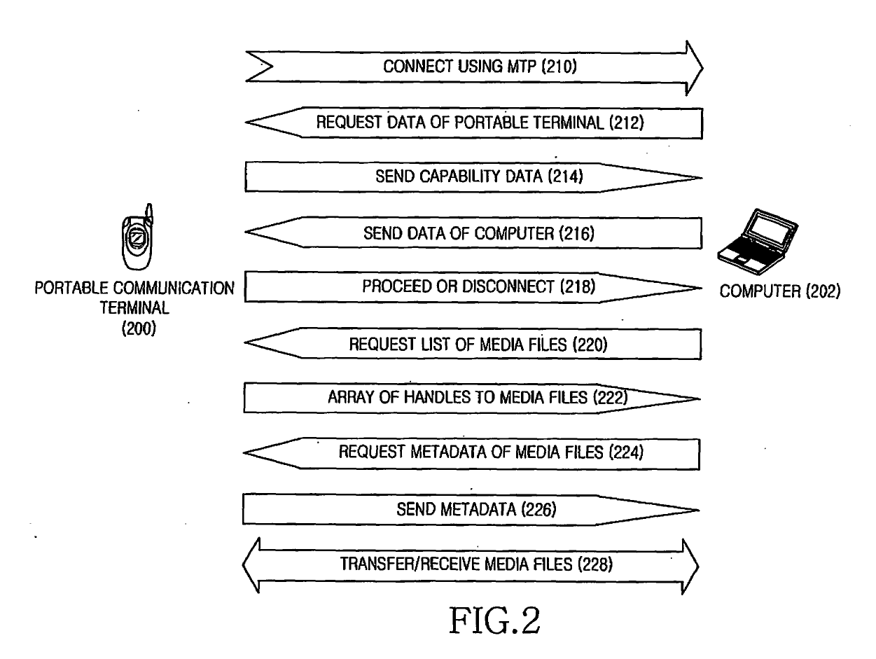

FIG. 2 shows the process of connecting an MTP between a portable terminal and a computer according to the present invention.

Referring to FIG. 2, first, when a portable terminal 200 and a computer 202 supporting MTP are connected for use in step 210, the computer 202 requests a data transfer in step 212 from the portable terminal 200, and the portable terminal 200 that receives the request for the data transfer sends data on its capability to the computer 202 in step 214. This data includes data on the memory (in terms of internal and external memory) and characteristics of the portable terminal. Here, the memory data includes memory type, total memory size, remaining memory capacity, description data, serial numbers, etc., and the characteristic data of the portable terminal includes operation codes, lists of supported functions, manufacturer, model name, version data, etc. Here, the computer 202 can be a desktop computer, a laptop computer or a portable type computer.

Then, the computer 202 transfers its own data (for example, an ID code) to the portable terminal 200 for authentication in step 216, and the portable terminal 200 checks the computer's 202 data to determine whether the computer has been authorized by the user of the portable terminal in step 218. If it is determined that the computer 202 has not been authorized, the connection between the portable terminal 200 and the computer 202 is terminated. If it is determined that the computer 202 has been authorized, the portable terminal 200 notifies the user that the computer 202 has been authenticated and that files may be transferred.

Next, the computer 202 requests a list of media files stored in the memory of the portable terminal 200 in step 220, and the portable terminal 200 transfers the handles of the media files stored in its memory to the computer 202 in step 222. Then, the computer 202 requests a transfer of metadata of the media files stored in the portable terminal 200 in step 224, and the portable terminal transfers the metadata of the media files stored in its memory to the computer 202 in step 226. In step 228, the portable terminal 200 and the computer 202 respectively transfer and receive the media files.

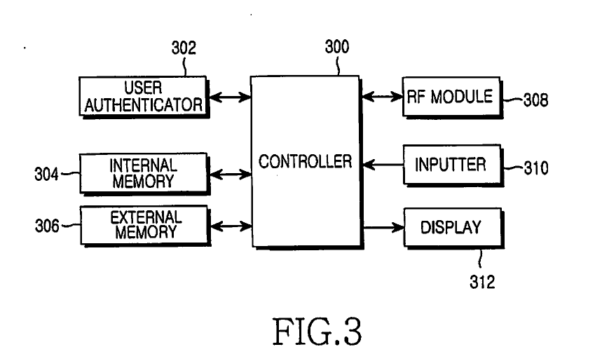

FIG. 3 is a block diagram showing the components of a portable terminal according to the present invention. Here, the portable terminal includes a controller 300, a user authenticator 302, an internal memory 304, an external memory 306, an RF module 308, an inputter 310, and a display 312.

Referring to FIG. 3, the controller 300 controls and processes the overall operations of the portable terminal, including the connecting of the terminal to a computer using MTP and the transferring media files to the connected computer. Also, the controller 300 outputs received computer data to the user authenticator 302 when the computer data is received. When a signal is received of a successful authentication of a computer by the user authenticator 302, the controller 300 sends a signal to the computer that authentication has been completed. When a signal is received of an unsuccessful authentication of a computer by the user authenticator 302, the controller displays a message on the display 312 requesting that the user input a user authentication number. Furthermore, after outputting a user authentication number input in the inputter 310 to the user authenticator 302, the controller 300 receives an input from the user authenticator 302 of whether the user authentication number matches an existing number. When an input that the user authentication number matches an existing number is received, the controller 300 sends a signal to the computer that authentication has successfully been completed. When an input that the user authentication number does not match an existing number is received, the controller 300 sends a signal to the computer that authentication was unsuccessful. And the controller 300 performs a function that deletes media files stored in the internal memory 304 and the external memory 306 or a function that blocks media files from being transferred stored in the internal memory 304 and the external memory 306. Then, the controller 300 terminates the connection with the computer.

The user authenticator 302 receives data on the currently connected computer from the controller 300, and outputs whether authentication of the computer has successfully been completed to the controller 300 after it is determined that the input data is the same as data of a computer that has been previously authenticated by a user. Also, when a user personal identification number (PIN) is input from the controller 300, the input user PIN is compared to a PIN preset by the user, and the result of whether they match is output to the controller 300.

The internal memory 304 is a memory installed inside the portable terminal, and the external memory 306 is a memory that is installable and detachable to and from the portable terminal. The internal memory 304 and external memory 306 may both store media files. Here, the internal memory 304 stores programs and various reference data for processing and controlling by the controller 300 of functions other than the media files, temporary data that is generated during the performing of the programs, various storable data, and data of computers that have successfully been authenticated according to the present invention.

The RF module 308 uses MTP to process signals that are transmitted and received for connecting to the computer. In particular, the RF module 308 of the present invention transfers and receives computer data from the computer to the controller 300, and transfers a signal through the controlling of the controller 300 that authentication of the computer has been successfully completed.

The inputter 310 has a plurality of function keys that provide data corresponding to each key pressed by a user to the controller 300. In particular, the inputter 310 receives an input of a user authentication number, and provides it to the controller 300.

The display 312 displays data on the state of operation of the portable terminal, and a limited number of characters. In the present invention, the display 312 displays whether a computer has successfully been authenticated through the controlling of the controller 300, and a message requesting that a user inputs the user authentication number.

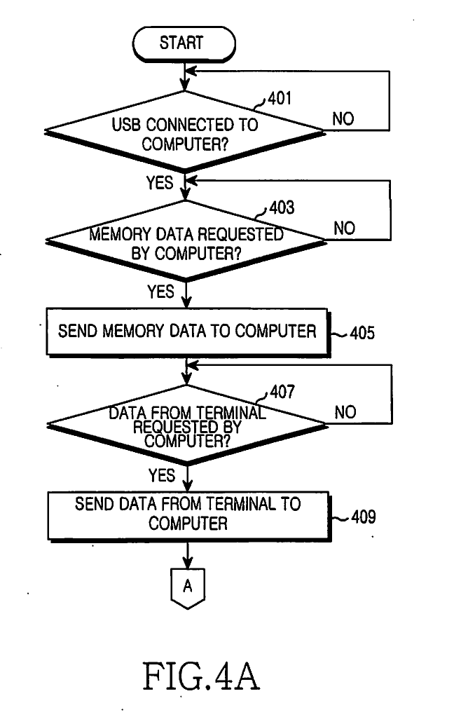

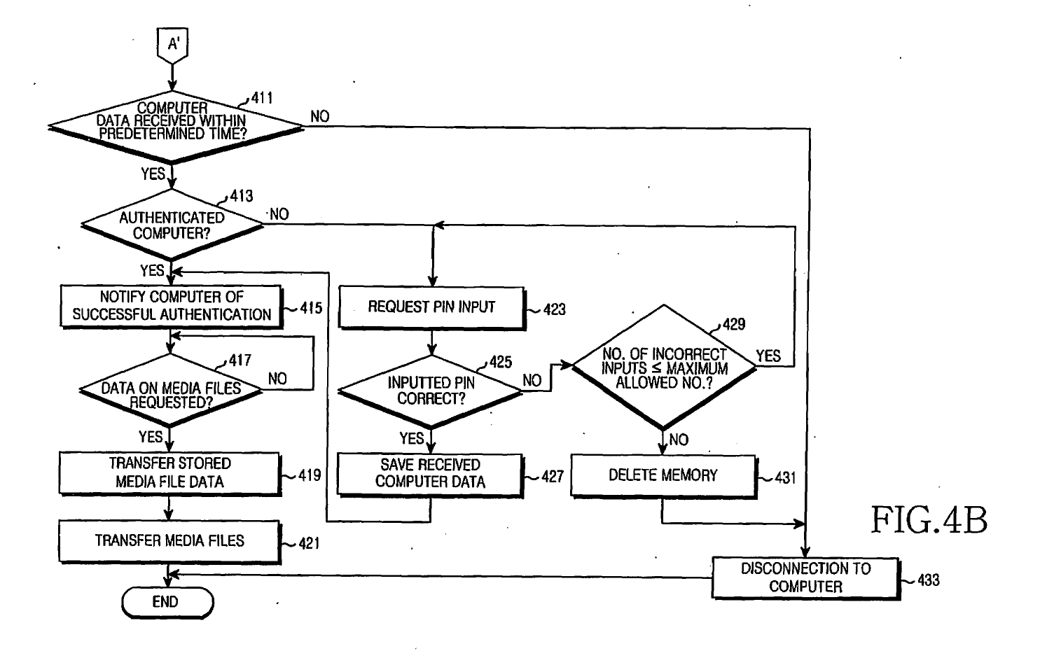

FIGS. 4A and 4B are flowcharts showing MTP connecting processes for preventing leaking of data from a portable terminal according to the present invention.

Referring to FIGS. 4A and 4B, the portable terminal first checks whether it is connected to the computer through a Universal Serial Bus (USB) port in step 401. When it is connected to the computer, the portable terminal checks in step 403 whether memory data has been requested by the computer for an MTP connection. If the memory data has been requested, the portable terminal transfers the memory data to the computer in step 405, and then performs step 407 in which it checks whether data of the portable terminal has been requested by the computer. When the portable terminal data has been requested, the portable terminal transfers the portable terminal data in step 409. Here, when an external memory is installed in the portable terminal, the procedure for requesting and transferring the memory data and requested data of the portable terminal is performed with respect to the internal memory, and then performed again with respect to the external memory.

Next in FIG. 4B, the portable terminal checks in step 411 whether the computer data (for example, ID codes) is received by the computer within a preset timeframe. If the computer data is not received within the preset timeframe, the portable terminal determines that the computer is a computer that does not support the authentication procedure according to the present invention, and performs step 433, in which it cancels the connection with the computer, and ends the process according to the present invention.

If the computer data is received within the predetermined timeframe, the portable terminal performs step 413, in which it compares received computer data to data of an already authenticated computer that has already been saved in the internal memory 304, and determines whether the computer is a computer that has already been successfully authenticated by the user. If the computer is a computer that has already been successfully authenticated, the portable terminal performs step 415 in which it signals that the computer has successfully been authenticated and media files may be transferred. Then, the portable terminal checks in step 417 whether transfer of data on stored media files is requested by the computer. If transfer of data on the stored media files is requested, the portable terminal performs step 419 in which it transfers data on media files stored in the internal and external memories, and then transfers the media files to the computer in step 421.

Then, the portable terminal ends the process of the present invention.

On the other hand, if the computer is determined in step 413 not to be a computer that has successfully been authenticated (that is, if the received computer data and the data of the authenticated computer pre-stored in the internal memory 304 do not match), the portable terminal performs step 423 in which it displays a message requesting an input of a PIN on the display 312. Next, when the user inputs the PIN, the portable terminal performs step 425 in which it determines whether the inputted PIN matches a preset PIN. When the input PIN matches the preset PIN, the portable terminal saves the received computer data in the internal memory 304 in step 427, and performs step 415.

Conversely, if it is determined step 425 that the input PIN does not match the preset PIN, the portable terminal counts the number of times that PINs are input incorrectly, and compares the number of incorrect inputs to a maximum number of allowed incorrect inputs in step 429. If the number of incorrect inputs is less than the maximum number of allowed incorrect inputs, the portable terminal returns to step 423 and requests that the user input a PIN.

If the number of incorrect inputs exceeds the maximum number of allowed incorrect inputs, the portable terminal notifies the user in step 431 that authentication of the computer was unsuccessful, deletes the media files stored in the internal memory 304 and the external memory 306, and disconnects the connection with the computer in step 433. Here, depending on a user's settings, the portable terminal may not delete the media files stored in the internal and external memories 304 and 306, and may only cancel the connection with the computer. Additionally, a user may preset media files that the user does not wish to be leaked, so that the portable terminal deletes only a portion of the stored media files (that is, the preset media files).

Then, the portable communication terminal ends the process of the present invention.

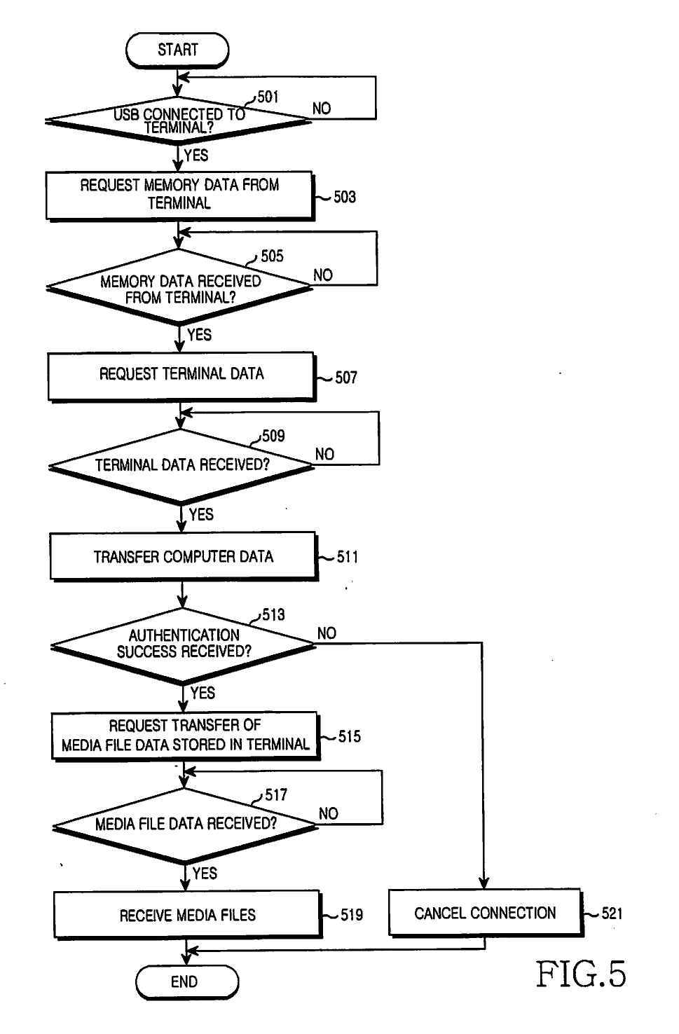

FIG. 5 is a flowchart showing a process of connecting a computer to a portable terminal according to the present invention.

Referring to FIG. 5, it is first detected in step 501 whether the computer is connected through a USB port to the portable terminal. If connected to the portable terminal, the computer 503 requests a transfer of memory data in step 503 for making an MTP connection with the portable terminal, and checks whether memory data is received from the portable terminal in step 505. If the memory data is received, the computer requests terminal data from the portable terminal in step 507, and checks in step 509 whether the requested terminal data is received. Here, if an external memory is installed in the portable terminal, the process of requesting and transferring the memory data and the portable terminal data is first performed with respect to the internal memory, and then once more with respect to the external memory.

Next, the computer performs step 511 in which it transfers data for authenticating the computer to the portable terminal, and then performs step 513 in which it detects whether a signal notifying the user that computer authentication was successful. If a signal notifying the user that computer authentication was unsuccessful is received, the computer performs step 521 in which it cancels the connection with the portable terminal and ends the process of the present invention.

On the other hand, if a signal notifying the user that computer authentication was successful is received, the computer performs step 515 in which it requests the transfer of data on the multimedia files stored in the portable terminal, and performs step 517 in which it checks whether the data on the requested multimedia files is received. When the data on the multimedia files is received, the computer performs step 519 in which it receives the multimedia files from the portable terminal, and ends the process of the present invention.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

As described above, the present invention performs an authentication process of a computer in a portable terminal when the portable terminal is connected using MTP to the computer. Thus, by allowing transfer of data stored in the memory of the portable terminal only in cases where the computer and/or a user is authenticated, the present invention prevents data that is not intended to be leaked to others by the user from being stolen, misappropriated or leaked.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of preventing data leakage from a portable terminal, comprising the steps of:
checking whether computer identification (ID) data from a computer is received when the portable terminal is connected to the computer using a media transfer protocol (MTP); and
performing a computer authentication using the computer ID data, when the computer ID data is received.

2. The method of claim 1, wherein the step of performing the computer authentication comprises:
determining whether the received computer ID data matches pre-stored ID data of an authenticated computer; and
notifying the connected computer of a successful authentication when the received computer ID data matches the pre-stored ID data.

3. The method of claim 2, further comprising:
requesting an input of a user personal identification number (PIN) when the received computer ID data does not match the pre-stored ID data;
determining whether the input user PIN matches a preset user PIN; and
storing the received computer ID data and notifying the connected computer of a successful authentication, when the user PIN matches the preset user PIN.

4. The method of claim 3, further comprising:
calculating a number of incorrect inputs of the user PIN and comparing the number to a preset maximum number of incorrect inputs, when the input user PIN does not match the preset user PIN; and
notifying the connected computer of an unsuccessful authorization when the calculated number of incorrect inputs exceeds the preset maximum number.

5. The method of claim 4, further comprising re-requesting an inputting of the user PIN when the calculated number of incorrect inputs is less than or equal to the preset maximum number.

6. The method of claim 1, further comprising transferring data to the computer when a result of the computer authentication yields a successful authentication of the connected computer.

7. The method of claim 1, further comprising canceling the connection between the portable terminal and the computer when a result of the computer authentication yields an unsuccessful authentication of the connected computer.

8. The method of claim 1, further comprising deleting data stored in a memory of the portable terminal when a result of the computer authentication yields an unsuccessful authentication of the connected computer.

9. The method of claim 8, wherein the data is deleted entirely or a partially of the data stored in the memory, according to user settings.

10. A method of operating a computer to prevent data leakage from a portable terminal, comprising the steps of:
transferring computer ID data to the portable terminal when the computer is connected to the portable terminal using MTP; and
requesting content data stored in the portable terminal when a signal signaling a successful authentication is received from the portable terminal.

11. The method of claim 10, further comprising canceling the connection between the computer and the portable terminal when a signal signaling an unsuccessful authentication is received from the portable terminal.

12. An apparatus for preventing data leakage from a portable terminal, comprising:
a checking unit for determining whether a computer authentication is successful using ID data of a computer and a user PIN, when the portable terminal is connected to the computer using an MTP; and
a controller for maintaining or canceling the connection between the portable terminal and the computer according to whether the computer authentication is successful.

13. The apparatus of claim 12, further comprising:
a display for requesting an input of the user PIN; and
an inputter for inputting the user PIN.

14. The apparatus of claim 12, wherein the controller deletes data stored in a memory of the portable terminal entirely or partially, according to a user setting, when the computer authentication is unsuccessful.

15. A portable terminal for preventing data leakage comprising:
a checking unit for determining whether a computer authentication is successful using ID data of a computer and a user PIN, when the portable terminal is connected to the computer using an MTP.

16. The portable terminal of claim 15, further comprising:
a controller for maintaining or canceling the connection between the portable terminal and the computer according to whether the computer authentication is successful;
a display for requesting an input of the user PIN; and
an inputter for inputting the user PIN.

17. The portable terminal of claim 16, wherein the controller deletes data stored in a memory of the portable terminal entirely or partially, according to a user setting, when the computer authentication is unsuccessful.

18. A computer to prevent data leakage from a portable terminal, comprising:
means for transferring computer ID data to the portable terminal when the computer is connected to the portable terminal using MTP; and
means for requesting content data stored in the portable terminal when a signal signaling a successful authentication is received from the portable terminal.

19. The computer of claim 18, further comprising means for canceling the connection between the computer and the portable terminal when a signal signaling an unsuccessful authentication is received from the portable terminal.

20. A computer-readable recording medium having recorded thereon a program for preventing data leakage in a portable terminal, comprising:
a first code segment, for checking whether computer identification (ID) data from a computer is received when the portable terminal is connected to the computer using a media transfer protocol (MTP); and
a second code segment, for performing a computer authentication using the computer ID data, when the computer ID data is received.
